(19) United States
(12) Patent Application Publication
(10) Pub. No.: US 2023/0252132 A1
(43) Pub. Date: Aug. 10, 2023

(54) CONTROL DEVICE, COMPUTER PROGRAM PRODUCT, AND CONTROL SYSTEM

(71) Applicant: KABUSHIKI KAISHA TOSHIBA, Tokyo (JP)

(72) Inventor: Jun KANAI, Inagi Tokyo (JP)

(73) Assignee: KABUSHIKI KAISHA TOSHIBA, Tokyo (JP)

(21) Appl. No.: 17/822,401

(22) Filed: Aug. 25, 2022

(30) Foreign Application Priority Data
Feb. 8, 2022 (JP) 2022-017652

(51) Int. Cl. G06F 21/55; G06F 21/56

(52) U.S. Cl. CPC G06F 21/552; G06F 21/554; G06F 21/567

(57) ABSTRACT

A control device includes a hardware processor configured to: acquire threat information indicating one or more threat events occurring in a monitoring target system; generate attack information indicating a plurality of detection target attacks to be detected in order to detect the one or more threat events among a plurality of attacks launched on the monitoring target system; generate a plurality of log sets each indicating a combination of one or more detectable logs enabling to detect all of the plurality of detection target attacks, based on an attack-log table that indicates a detectable log among a plurality of logs acquired from the monitoring target system; acquire easinesses representing littleness of restrictions for monitoring the one or more detectable logs, and calculate priorities indicating degrees of priority of monitoring, based on the easinesses; and output the plurality of log sets and the priorities of the plurality of log sets.

### CROSS-REFERENCE TO RELATED APPLICATIONS

This application is based upon and claims the benefit of priority from Japanese Patent Application No. 2022-017652, filed on Feb. 8, 2022; the entire contents of which are incorporated herein by reference.

### FIELD

Embodiments described herein relate generally to a control device, a computer program product, and a control system.

### BACKGROUND

In recent years, cyberattacks targeting control systems frequently occur, and security measures are urgently needed. Among others, it is important to record and monitor logs as a security measure. Therefore, the control system has to record various logs.

The types of logs acquired from the control system are enormous. On the other hand, since resources for recording logs are finite, the number of logs to be recorded is preferably small.

However, the logs acquired vary depending on the control system. In addition, the incidents assumed and the attacks to be detected vary depending on the control system. Therefore, the logs to be recorded vary depending on the control system.

Also, in the control system, functions for generating logs and acquiring logs are limited. Further, in many control systems such as social infrastructure systems, it is often difficult to significantly add functions. Therefore, it is preferable to be able to take maximum security measures using the limited functions in consideration of the restriction inherent in the control system.

### BRIEF DESCRIPTION OF THE DRAWINGS

FIG. 1 is a diagram illustrating a configuration of a control system according to a first embodiment;

FIG. 2 is a diagram illustrating a configuration of a log recommendation device according to the first embodiment;

FIG. 3 is a diagram illustrating an example of a threat event;

FIG. 4 is a diagram illustrating an example of procedure information;

FIG. 5 is a diagram illustrating a first example of attack information;

FIG. 6 is a diagram illustrating a second example of the attack information;

FIG. 7 is a diagram illustrating an example of an attack-log database;

FIG. 8 is a diagram illustrating an example of an attack-log table;

FIG. 9 is a diagram illustrating examples of log sets;

FIG. 10 is a diagram illustrating an example of easinesses;

FIG. 11 is a diagram illustrating examples of weights;

FIG. 12 is a diagram illustrating an example in which the easinesses are replaced with numerical values;

FIG. 13 is a diagram illustrating an example of calculating an addition value for each restriction factor;

FIG. 14 is a diagram illustrating a first calculation example of priorities;

FIG. 15 is a diagram illustrating a second calculation example of priorities;

FIG. 16 is a flowchart illustrating a flow of processing of the log recommendation device according to the first embodiment;

FIG. 17 is a diagram illustrating a configuration of the log recommendation device according to a second embodiment;

FIG. 18 is a flowchart illustrating a flow of processing of the log recommendation device according to the second embodiment; and

FIG. 19 is a diagram illustrating an example of a hardware configuration of the log recommendation device.

### DETAILED DESCRIPTION

According to an embodiment, a control device includes a hardware processor. The hardware processor is configured to: acquire threat information indicating one or more threat events occurring in a monitoring target system; generate, for each of the one or more threat events, attack information indicating a plurality of detection target attacks to be detected in order to detect the one or more threat events among a plurality of attacks launched on the monitoring target system; generate, for each of the plurality of detection target attacks indicated in the attack information, a plurality of log sets each indicating a combination of one or more detectable logs enabling to detect all of the plurality of detection target attacks, based on an attack-log table that indicates a detectable log enabling to detect an attack among a plurality of logs acquired from the monitoring target system; acquire, for each of the plurality of log sets, easinesses representing littleness of restrictions for monitoring the one or more detectable logs, and calculate, for each of the plurality of log sets, priorities indicating degrees of priority of monitoring, based on the easinesses of the one or more detectable logs; and output the plurality of log sets and the priorities of the plurality of log sets.

Hereinbelow, embodiments will be described with reference to the drawings.

### First Embodiment

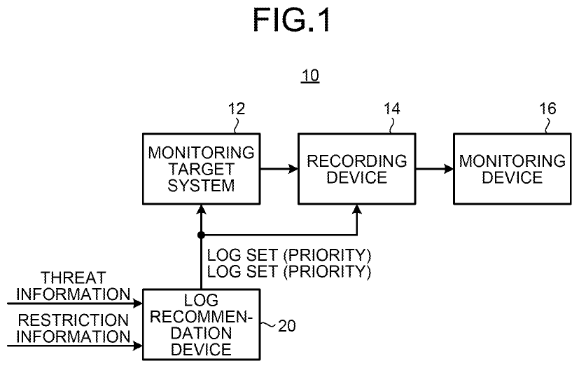

FIG. 1 is a diagram illustrating a configuration of a control system 10 according to a first embodiment. The control system 10 includes a monitoring target system 12, a recording device 14, a monitoring device 16, and a log recommendation device 20.

The monitoring target system 12 is, for example, a system that controls and manages a plurality of devices. For example, the monitoring target system 12 is a system that controls and manages infrastructures such as roads, railways, a power network, a water network, and a communication network. Alternatively, the monitoring target system 12 may be a plant system for a power generation plant, a chemical plant, and a manufacturing plant. The monitoring target system 12 may be an information processing system including one or more information processing devices and the like.

The recording device 14 records a plurality of logs acquired from the monitoring target system 12. For example, the recording device 14 acquires data input into the monitoring target system 12, data output from the monitoring target system 12, data measured by devices provided in the monitoring target system 12, control data for these devices, and the like, and records time-series data of these pieces of data as logs.

The monitoring device 16 monitors a plurality of logs recorded in the recording device 14 and detects a threat event occurring in the monitoring target system 12. Also, in a case where a threat event occurs in the monitoring target system 12, the monitoring device 16 may analyze a plurality of logs recorded in the recording device 14 to find a factor or the like causing the threat event. The monitoring device 16 may mechanically detect a threat event by executing a monitoring program or the like, or may detect a threat event in cooperation with an operator.

The log recommendation device 20 is an example of a control device. The log recommendation device 20 acquires threat information indicating one or more threat events to be detected by the monitoring device 16. The log recommendation device 20 also acquires restriction information indicating a weight for each of a plurality of restriction factors that restrict monitoring processing for detecting a threat event. The log recommendation device 20 then generates a plurality of log sets on the basis of the threat information and the restriction information. Each of the plurality of log sets indicates one or a combination of a plurality of logs to be monitored by the monitoring device 16. Further, the log recommendation device 20 calculates a priority indicating the degree of priority of monitoring for each of the plurality of log sets. The priority may be a numerical value such as a score or may be an order. The log recommendation device 20 outputs the calculated priority in association with each of the plurality of log sets.

Note that the log recommendation device 20 may select and output one or more log sets each having a higher priority from among the plurality of log sets. In a case where one or more log sets each having a higher priority are selected and output, the log recommendation device 20 does not have to output the priority.

The log recommendation device 20 gives the plurality of generated log sets and the respective priorities of the plurality of log sets to the monitoring target system 12. In this case, the monitoring target system 12 selects a plurality of pieces of data for generating one or more logs indicated in one or more log sets the priorities of which are high, and gives the selected data to the recording device 14. Then, the recording device 14 records logs of the data acquired from the monitoring target system 12.

Note that the monitoring target system 12 may give all of the plurality of pieces of generated data to the recording device 14. In this case, the log recommendation device 20 gives the plurality of generated log sets and the respective priorities of the plurality of log sets to the recording device 14. Then, the recording device 14 selects data for generating one or more logs indicated in one or more log sets the priorities of which are high from among all of the plurality of pieces of data generated in the monitoring target system 12, and records logs of the selected data.

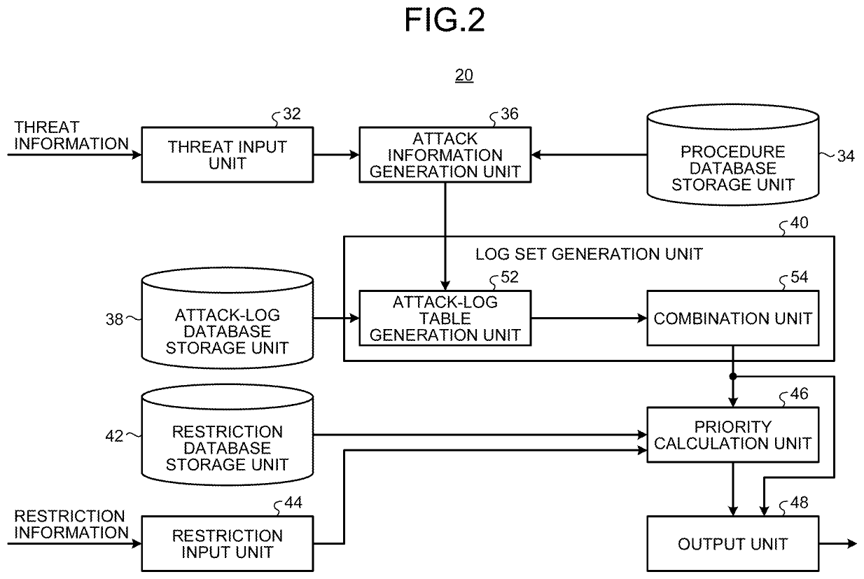

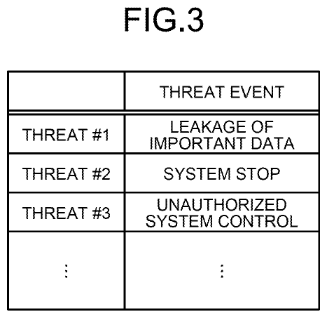

FIG. 2 is a diagram illustrating a configuration of the log recommendation device 20 according to the first embodiment. Hereinbelow, a configuration of the log recommendation device 20 illustrated in FIG. 2 will be described with reference to FIGS. 3 to 15.

The log recommendation device 20 includes a threat input unit 32, a procedure database storage unit 34, an attack information generation unit 36, an attack-log database storage unit 38, a log set generation unit 40, a restriction database storage unit 42, a restriction input unit 44, a priority calculation unit 46, and an output unit 48.

The threat input unit 32 acquires threat information indicating one or more threat events occurring in the monitoring target system 12. For example, the threat input unit 32 acquires threat information input by a user such as a system administrator.

For example, as illustrated in FIG. 3, the threat events are leakage of important data, system stop, unauthorized system control, and the like. The threat events may be, for example, events obtained by analysis using a general threat analysis method such as STRIDE.

The procedure database storage unit 34 stores procedure information indicating an attack procedure of one or more attacks launched on the monitoring target system 12 before a threat occurs. The log recommendation device 20 may acquire the procedure information from a database provided by a server or the like without including the procedure database storage unit 34.

For example, in the threat of “system stop”, by the time when the threat occurs, one or more attacks are executed on the monitoring target system 12 by one or more attack procedures. For example, the threat of “system stop” occurs in the procedure of searching for the monitoring target system 12, intruding into the monitoring target system 12, and executing a program for stopping the monitoring target system 12. Examples of the more specific attack for intruding into the monitoring target system 12 include a method of obtaining a password for a remote access function and intruding with the obtained password and a method of intruding taking advantage of vulnerability of the program. The procedure database storage unit 34 stores procedure information indicating such a specific attack procedure and attack content.

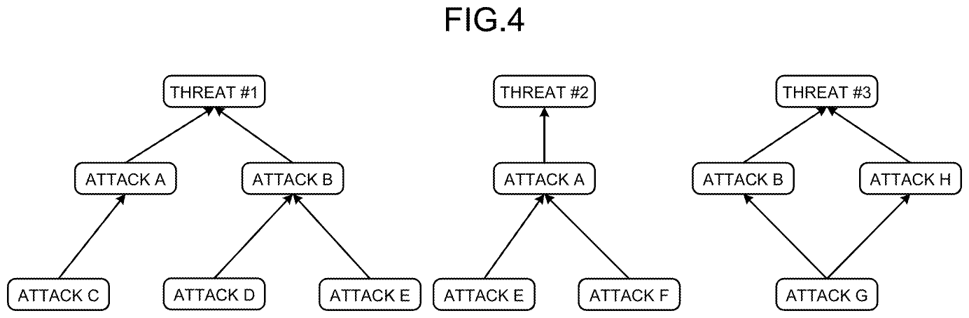

For example, as illustrated in FIG. 4, the procedure database storage unit 34 may store procedure information in which attack procedures are described in a tree shape. The procedure information illustrated in FIG. 4 indicates that, in a case where threat #1 is to occur, attack A or attack B is executed, for example. The procedure information illustrated in FIG. 4 also indicates that, in a case where attack A is to be executed, attack C is executed before attack A is executed. The procedure information illustrated in FIG. 4 further indicates that, in a case where attack B is to be executed, attack D or attack E is executed before attack B. The procedure information is generated by, for example, an analysis method called attack tree analysis. Also, the procedure information may be generated using a framework for studying attack tactics such as MITRE ATT&CK, or may be generated using an attack simulation function called Breach and Attack Simulation (BAS).

The attack information generation unit 36 refers to the procedure information stored in the procedure database storage unit 34, and generates attack information indicating a plurality of detection target attacks to be detected in order to detect one or more threat events input by the threat input unit 32 among a plurality of attacks launched on the monitoring target system 12. The attack information is a list indicating contents of a plurality of attacks.

For example, for each of one or more threat events input by the threat input unit 32, the attack information generation unit 36 may cause the plurality of detection target attacks indicated in the attack information to include all of one or more attacks indicated in the procedure information.

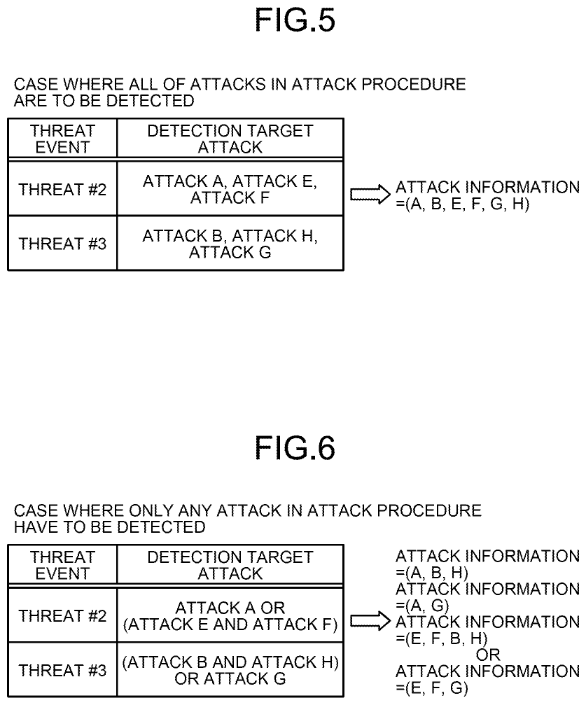

For example, FIG. 4 illustrates that attack A, and attack E or attack F, are executed in a case where threat #2 is to occur, and that attack B or attack H, and attack G, are executed in a case where threat #3 is to occur. In a case where threat #2 and threat #3 are provided as the threat information, the attack information generation unit 36 generates attack information including attacks A, B, E, F, G, and H as illustrated in FIG. 5. As a result, for each of one or more threat events, the attack information generation unit 36 can cause the plurality of detection target attacks indicated in the attack information to include all of one or more attacks indicated in the procedure information.

Also, for example, for each of one or more threat events input by the threat input unit 32, the attack information generation unit 36 may cause the plurality of detection target attacks indicated in the attack information to include one or more attacks with which at least a target threat event can be detected among one or more attacks indicated in the procedure information.

For example, as illustrated in FIG. 6, in a case where threat #2 and threat #3 are provided as the threat information, the attack information generation unit 36 may generate attack information including attacks A, B, and H since threat #2 can be detected by analyzing attack A, and threat #3 can be detected by analyzing attack B and attack H. Also, the attack information generation unit 36 may generate attack information including attacks A and G since threat #2 can be detected by analyzing attack A, and threat #3 can be detected by analyzing attack G. Further, the attack information generation unit 36 may generate attack information including attacks E, F, B, and H since threat #2 can be detected by analyzing attack E and attack F, and threat #3 can be detected by analyzing attack B and attack H. Still further, the attack information generation unit 36 may generate attack information including attacks E, F, and G since the monitoring device 16 can detect threat #2 by analyzing attack E and attack F and detect threat #3 by analyzing attack G. As a result, for each of one or more threat events, the attack information generation unit 36 can cause the plurality of detection target attacks indicated in the attack information to include one or more attacks with which at least a target threat event can be detected among one or more attacks indicated in the procedure information.

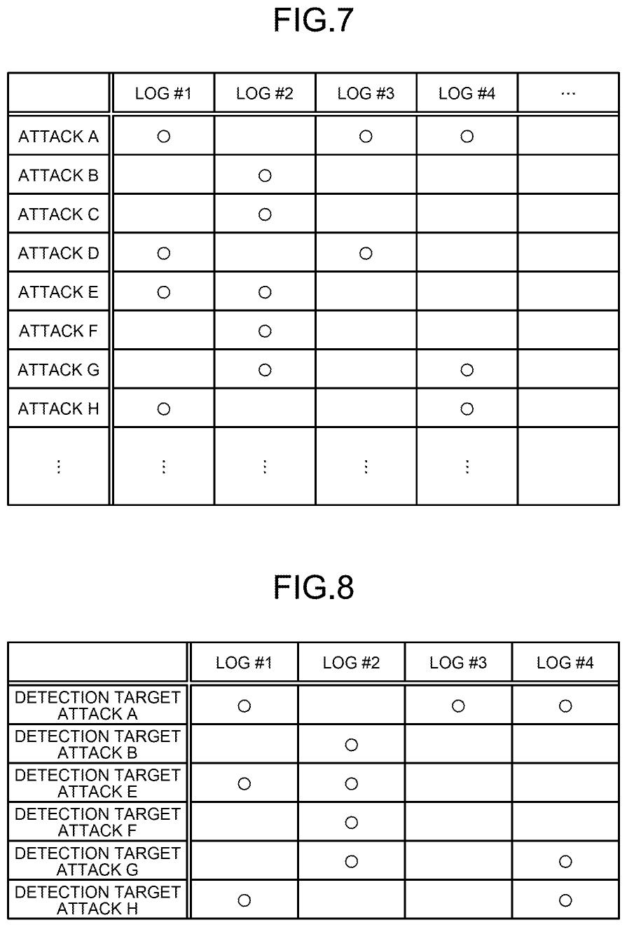

The attack-log database storage unit 38 stores an attack-log database. In the attack-log database, for example, as illustrated in FIG. 7, for each of a plurality of attacks launched on the monitoring target system 12, detectable logs enabling to detect the attack are registered in advance.

The log set generation unit 40 generates, for each of a plurality of detection target attacks indicated in the attack information, a plurality of log sets each indicating a combination of one or more detectable logs enabling to detect all of the plurality of detection target attacks on the basis of an attack-log table. The attack-log table indicates detectable logs enabling to detect an attack among a plurality of logs acquired from the monitoring target system 12. For example, the log set generation unit 40 includes an attack-log table generation unit 52 and a combination unit 54.

The attack-log table generation unit 52 generates an attack-log table by referring to the attack-database stored in the attack-log database storage unit 38. For example, as illustrated in FIG. 8, in a case where attacks A, B, E, F, G, and H are included in the attack information as detection target attacks, the attack-log table generation unit 52 extracts portions related to attacks A, B, E, F, G, and H in the attack-database, and generates an attack-log table. For example, the attack-log table in FIG. 8 indicates that log #1, log #3 and log #4 are detectable logs enabling to detect attack A, log #2 is a detectable log enabling to detect attack B, log #1 and log #2 are detectable logs enabling to detect attack E, log #2 is a log detectable log enabling to detect attack F, log #2 and log #4 are detectable logs enabling to detect attack G, and log #1 and log #4 are detectable logs enabling to detect attack H.

The combination unit 54 detects combinations each including one or more detectable logs enabling to detect all of a plurality of detection target attacks with reference to the attack-log table to generate a plurality of log sets. For example, the combination unit 54 at least generates a log set serving as a combination of one or more detectable logs that is/are the minimum necessary for detecting all of the plurality of detection target attacks.

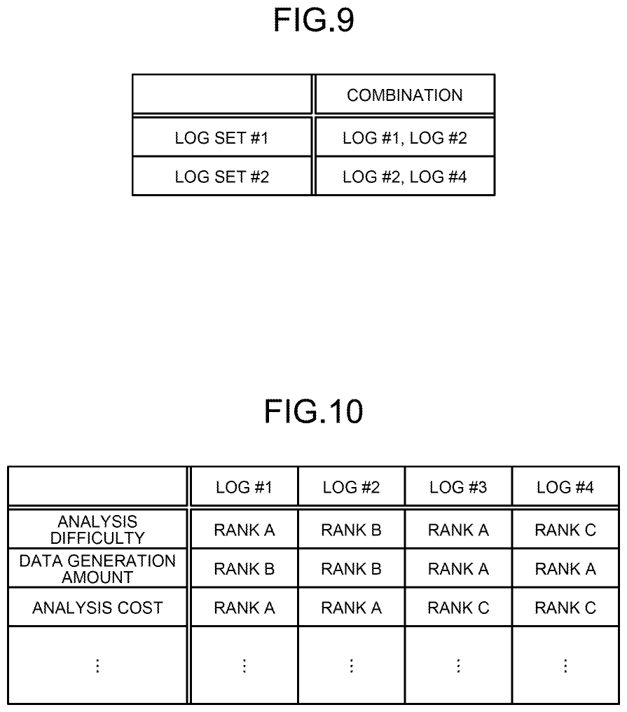

The attack-log table illustrated in FIG. 8 indicates that all of the detection target attacks A, B, E, F, G, and H can be detected by analyzing log #1 and log #2. In this case, it is not necessary to analyze logs other than log #1 and log #2. In addition, the attack-log table illustrated in FIG. 8 indicates that all of the detection target attacks A, B, E, F, G, and H can also be detected by analyzing log #2 and log #4. In this case, it is not necessary to analyze logs other than log #2 and log #4. Therefore, by referring to the attack-log table illustrated in FIG. 8, the combination unit 54 can generate log set #1 indicating a combination of log #1 and log #2 and log set #2 indicating a combination of log #2 and log #4 as illustrated in FIG. 9.

Note that the combination unit 54 may additionally generate a log set obtained by adding another log to the minimum necessary set of one or more detectable logs. For example, the combination unit 54 may further generate log set #3 obtained by adding log #3 to log #1 and log #2.

The restriction database storage unit 42 stores a restriction database. In the restriction database, for example, as illustrated in FIG. 10, the easinesses representing the littleness of the restrictions for monitoring are set in advance for each of a plurality of logs and each of a plurality of restriction factors that impose a restriction on the execution of the monitoring processing.

The plurality of restriction factors include, for example, at least one of analysis difficulty, a data generation amount, and an analysis cost. The analysis difficulty represents, for example, a restriction that, in order to analyze the corresponding log, a security expert must deal with the analysis. Also, the data generation amount represents a restriction that, in order to analyze the corresponding log, a large storage area needs to be secured for log storage. The analysis cost represents a restriction that, in order to analyze the corresponding log, expensive analysis software must be introduced, which costs a lot.

The easiness for the analysis difficulty is higher as the log analysis is easier, and lower as the log analysis is more difficult. For example, the easinesses of the analysis difficulties in FIG. 10 represent that the log analysis is easy in the case of rank A, present that the log analysis is normal in the case of rank B, and represent that the log analysis is difficult in the case of rank C.

Also, the easiness for the data generation amount is higher as the amount of data generated per unit time is smaller, and is lower as the data generation amount is larger. For example, the easinesses of the data generation amounts in FIG. 10, represent the data amount per unit time is small in the case of rank A, represent that the data amount per unit time is normal in the case of rank B, and represent that the data amount per unit time is large in the case of rank C.

Further, the easiness for the analysis cost is higher as the cost for analyzing the log is lower, and is lower as the cost is higher. For example, the easinesses of the analysis cost in FIG. 10, represent that the analysis cost is low in the case of rank A, represent that the analysis cost is normal in the case of rank B, and represent that the analysis cost is high in the case of rank C.

Note that the easinesses are represented in three ranks in the example of FIG. 10, but may be represented in two ranks. Alternatively, the easinesses may be represented in four or more ranks.

The restriction input unit 44 receives a weight of each of the plurality of restriction factors from the user. The weight is a value indicating a rate at which the corresponding restriction factor is regarded as important. For example, in a case where the analysis difficulty, the data generation amount, and the analysis cost are included as the plurality of restriction factors, the restriction input unit 44 receives an input of a weight for each of the analysis difficulty, the data generation amount, and the analysis cost from the user.

Also, in the restriction input unit 44 may be registered in advance a plurality of options in each of which weights are respectively assigned to the plurality of restriction factors. In this case, the restriction input unit 44 causes the user to select any one of the plurality of options.

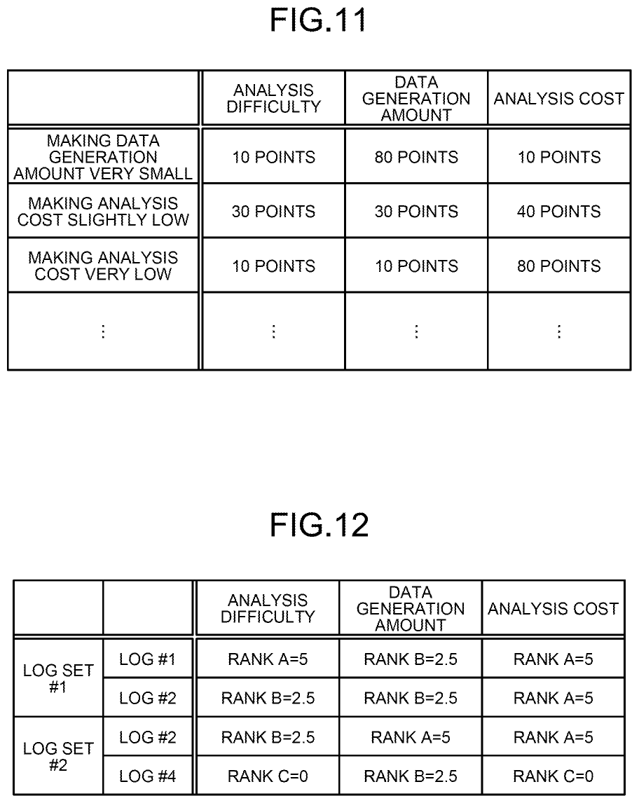

For example, as illustrated in FIG. 11, in the restriction input unit 44 may be registered a plurality of options in each of which weights are respectively assigned to the analysis difficulty, the data generation amount, and the analysis cost so that the total of the weights is 100 points. For example, in the option of making the data generation amount very small, a weight of 10 points is assigned to the analysis difficulty, a weight of 80 points is assigned to the data generation amount, and a weight of 10 points is assigned to the analysis cost. Also, for example, in the option of making the analysis cost slightly low, a weight of 30 points is assigned to the analysis difficulty, a weight of 30 points is assigned to the data generation amount, and a weight of 40 points is assigned to the analysis cost. Further, for example, in the option of making the analysis cost very low, a weight of 10 points is assigned to the analysis difficulty, a weight of 10 points is assigned to the data generation amount, and a weight of 80 points is assigned to the analysis cost. In a case where any of the plurality of options is selected, the restriction input unit 44 outputs the weights respectively assigned to the plurality of restriction factors in the selected option.

The priority calculation unit 46 acquires a plurality of log sets generated by the log set generation unit 40. The priority calculation unit 46 refers to the restriction database and acquires, for each of the plurality of log sets, the easiness of each of one or more detectable logs. In this case, the priority calculation unit 46 refers to the restriction database and acquires the easiness of each of one or more detectable logs for each of a plurality of restriction factors. The priority calculation unit 46 then replaces the acquired the easiness with a corresponding numerical value. For example, as illustrated in FIG. 12, the priority calculation unit 46 replaces the easinesses for rank A with 5, those for rank B with 2.5, and those for rank C with 0.

Subsequently, the priority calculation unit 46 calculates, for each of the plurality of log sets, an addition value obtained by adding the easinesses of one or more detectable logs for each of the plurality of restriction factors.

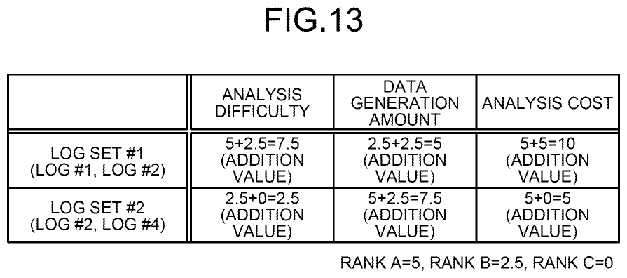

For example, as illustrated in FIG. 13, regarding the analysis difficulty of log set #1, the priority calculation unit 46 calculates an addition value obtained by adding 5, which is a numerical value for rank A in log #1 and 2.5, which is a numerical value for rank B in log #2. Also, regarding the data generation amount of log set #1, the priority calculation unit 46 calculates an addition value obtained by adding 2.5, which is a numerical value for rank B in log #1 and 2.5, which is a numerical value for rank B in log #2. Further, regarding the analysis cost of log set #1, the priority calculation unit 46 calculates a value obtained by adding 5, which is a numerical value for rank A in log #1 and 5, which is a numerical value for rank A in log #2. The priority calculation unit 46 similarly calculates an addition value for each of the analysis difficulty, the data generation amount, and the analysis cost for log set #2.

Subsequently, the priority calculation unit 46 acquires from the restriction input unit 44 the weight of each of the plurality of restriction factors received from the user. Then, the priority calculation unit 46 calculates, for each of the plurality of log sets, a priority indicating the degree of priority of monitoring on the basis of the easiness of each of one or more detectable logs. For example, the priority calculation unit 46 calculates, for each of the plurality of log sets, a priority by combining the easinesses of one or more detectable logs with a predetermined arithmetic expression. For example, for each of the plurality of log sets, the priority calculation unit 46 multiplies an addition value for each of the plurality of restriction factors by a corresponding weight, and calculates a total value obtained by summing the addition values multiplied by the weights for all of the plurality of restriction factors. Further, for each of the plurality of log sets, the priority calculation unit 46 divides the total value by the number of one or more detectable logs to calculate a priority.

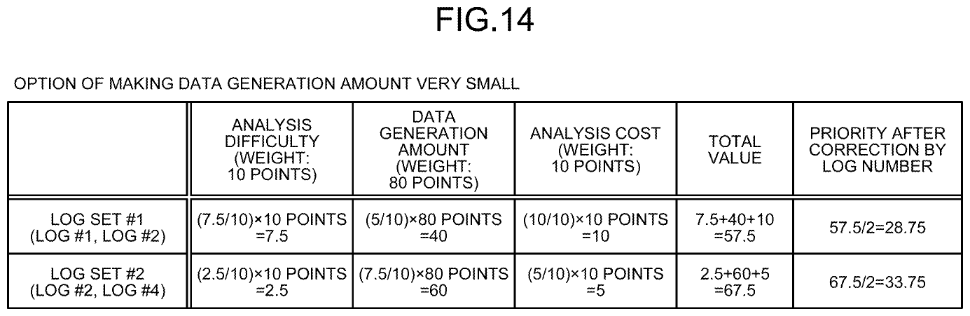

For example, as illustrated in FIG. 14, in a case where the option of making the data generation amount very small is received, the priority calculation unit 46 acquires 10 points as the weight of the analysis difficulty, 80 points as the weight of the data generation amount, and 10 points as the weight of the analysis cost. In this case, the priority calculation unit 46 calculates, for log set #1, a total value (57.5) obtained by summing a value (7.5) obtained by multiplying, by 10 points, which is the weight of the analysis difficulty, a value obtained by dividing 7.5, which is the addition value of the analysis difficulty, by 10, a value (40) obtained by multiplying, by 80 points, which is the weight of the data generation amount, a value obtained by dividing 5, which is the addition value of the data generation amount, by 10, and a value (10) obtained by multiplying, by 10 points, which is the weight of the analysis cost, a value obtained by dividing 10, which is the addition value of the analysis cost, by 10.

The priority calculation unit 46 then calculates, as a priority of log set #1, a value (28.75) obtained by dividing the total value (57.5) by 2, which is the number of logs included in log set #1. Note that, in a case where the number of logs to be analyzed increases, it is assumed that the analysis difficulty becomes higher, the data generation amount becomes larger, and the analysis cost becomes higher. Therefore, the priority calculation unit 46 divides the total value by the number of logs to convert the total value into a value per log, so that a comparison can be made in terms of the priority between log sets regardless of the number of log sets. Also, in a case where the option of making the data generation amount very small is received, the priority calculation unit 46 executes calculation in a similar manner for log set #2 to calculate a priority (33.75).

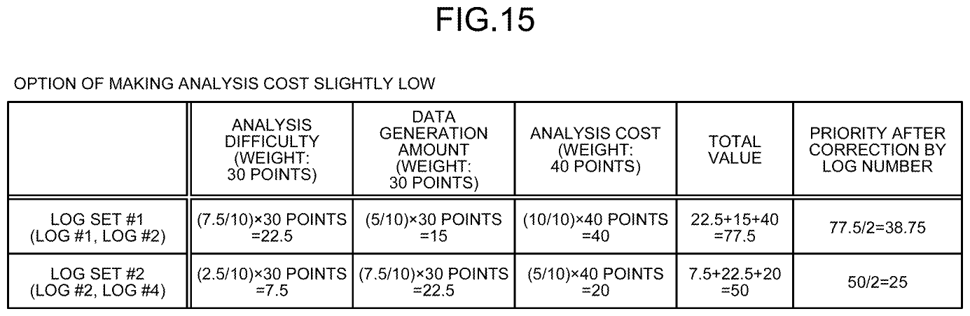

Also, for example, as illustrated in FIG. 15, in a case where the option of making the analysis cost slightly low is received, the priority calculation unit 46 acquires 30 points as the weight of the analysis difficulty, 30 points as the weight of the data generation amount, and 40 points as the weight of the analysis cost. In this case, the priority calculation unit 46 calculates, for log set #1, a total value (77.5) obtained by summing a value (22.5) obtained by multiplying, by 30 points, which is the weight of the analysis difficulty, a value obtained by dividing 7.5, which is the addition value of the analysis difficulty, by 10, a value (15) obtained by multiplying, by 30 points, which is the weight of the data generation amount, a value obtained by dividing 5, which is the addition value of the data generation amount, by 10, and a value (40) obtained by multiplying, by 40 points, which is the weight of the analysis cost, a value obtained by dividing 10, which is the addition value of the analysis cost, by 10. The priority calculation unit 46 then calculates, as a priority of log set #1, a value (38.75) obtained by dividing the total value (77.5) by 2, which is the number of logs included in log set #1. Also, in a case where the option of making the analysis cost slightly low is received, the priority calculation unit 46 executes calculation in a similar manner for log set #2 to calculate a priority (25).

Note that the priority calculation unit 46 may calculate the priority by another calculation method. In addition, the priority may be an order indicating the degree of priority of monitoring. For example, a machine learning model trained in advance may be prepared as the priority calculation unit 46, and a plurality of log sets and restriction information may be provided to the machine learning model so that the machine learning model can output the priority of each of the plurality of log sets. Also, the priority calculation unit 46 may calculate the priority by performing an arithmetic operation using a parameter by which a higher priority is given to a log set having a smaller number of logs.

The output unit 48 outputs the plurality of log sets generated by the log set generation unit 40 and the priorities of the plurality of log sets calculated by the priority calculation unit 46. Note that the output unit 48 may select and output one or more log sets each having a higher priority from among the plurality of log sets. In a case where one or more log sets each having a higher priority are selected and output, the output unit 48 does not have to output the priority.

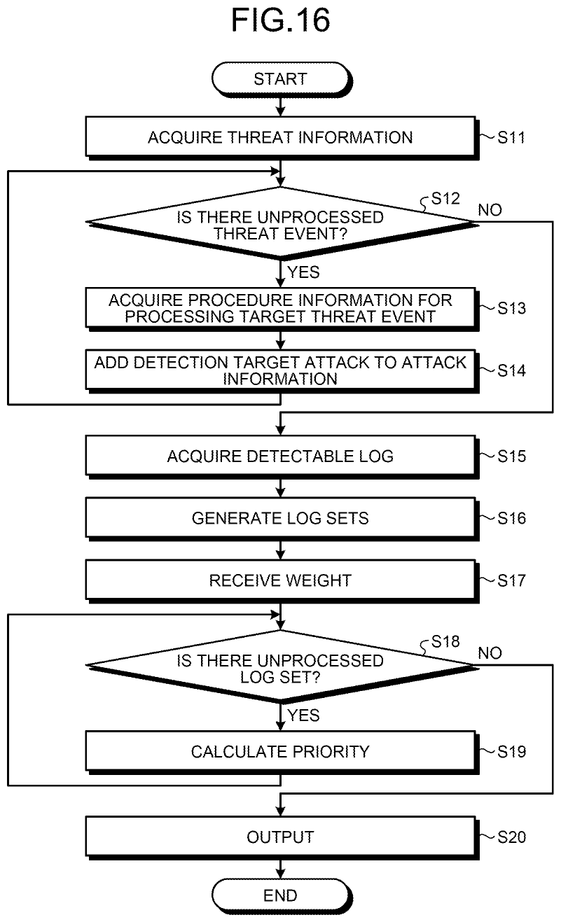

FIG. 16 is a flowchart illustrating a flow of processing of the log recommendation device 20 according to the first embodiment. The log recommendation device 20 according to the first embodiment executes processing according to the flow illustrated in FIG. 16.

First, in S11, the log recommendation device 20 acquires threat information indicating one or more threat events.

Subsequently, in S12, the log recommendation device 20 determines whether or not there is an unprocessed threat event among one or more threat events indicated in the threat information. In a case where there is an unprocessed threat event (Yes in S12), the log recommendation device 20 advances the processing to S13.

In S13, the log recommendation device 20 sets one of one or more threat events indicated in the threat information as a processing target threat event, and acquires procedure information indicating an attack procedure of one or more attacks for the processing target threat event. Subsequently, in S14, the log recommendation device 20 specifies one or more detection target attacks to be detected in order to detect the processing target threat event from among one or more attacks indicated in the acquired procedure information, and adds the one or more detection target attacks to attack information. Upon completion of the processing of S14, the log recommendation device 20 returns the processing to S12, and repeats the processing of S13 and S14 until there is no unprocessed threat event. In a case where there is no unprocessed threat event (No in S12), the log recommendation device 20 advances the processing to S15.

In S15, the log recommendation device 20 refers to an attack-log database and acquires a detectable log enabling to detect each of the plurality of detection target attacks indicated in the attack information to generate an attack-log table.

Subsequently, in S16, the log recommendation device 20 generates a plurality of log sets each indicating a combination of one or more detectable logs enabling to detect all of the plurality of detection target attacks on the basis of the attack-log table.

Subsequently, in S17, the log recommendation device 20 receives a weight of each of a plurality of restriction factors from the user. In this case, the log recommendation device 20 may cause the user to select any one option from among a plurality of options in each of which weights are respectively assigned to the plurality of restriction factors.

Subsequently, in S18, the log recommendation device 20 determines whether or not there is an unprocessed log set among the plurality of generated log sets. In a case where there is an unprocessed log set (Yes in S18), the log recommendation device 20 advances the processing to S19.

In S19, the log recommendation device 20 sets one of the plurality of generated log sets as a processing target log set, and calculates a priority for the processing target log set. Upon completion of the processing of S19, the log recommendation device 20 returns the processing to S18, and repeats the processing of S19 until there is no unprocessed log set. In a case where there is no unprocessed log set (No in S18), the log recommendation device 20 advances the processing to S20.

In S20, the log recommendation device 20 outputs the plurality of generated log sets and the priorities of the plurality of log sets calculated by the priority calculation unit 46 in association with the plurality of log sets. Alternatively, the log recommendation device 20 may select one or more log sets each having a higher priority from among the plurality of generated log sets, and output the selected one or more log sets. When the processing of S20 ends, the log recommendation device 20 ends this flow.

The aforementioned log recommendation device 20 according to the first embodiment can mechanically output a log set, indicating one or more logs, that efficiently detects a threat event. Also, the log recommendation device 20 can output a log set that reduces the influence of a plurality of restriction factors that impose a restriction on the monitoring processing. Further, the log recommendation device 20 can adjust weights representing the influences of the plurality of restriction factors according to the setting by the user. As a result, the log recommendation device 20 can output a log set in consideration of system-specific requirements such as analysis difficulty, a data generation amount, and an analysis cost. Therefore, the log recommendation device 20 can execute a maximum security measure using limited functions on a social infrastructure system or the like in which resources for generating or adding logs are significantly restricted, and in which it is difficult to significantly add functions.

Note that the log recommendation device 20 can be used not only to detect a threat event such as a cyberattack in advance, but also to analyze an attack called a forensic, for example. In this case, the log recommendation device 20 has only to output, as a detectable log enabling to detect an attack, a log in which information obtained from the log at the time of performing the forensic is sufficient. The log recommendation device 20 may also be used to detect a threat event to be caused by a failure before the threat event occurs or analyze a threat event that has caused by a failure. In this case, the log recommendation device 20 may change each of the databases and the priority calculation algorithm according to the purpose of using the logs.

### Second Embodiment

Next, the control system 10 according to a second embodiment will be described. Since the control system 10 according to the second embodiment has substantially the same function and configuration as those of the first embodiment described with reference to FIGS. 1 to 16, components having substantially the same function and configuration are labeled with the same reference signs, and detailed description thereof will be omitted except for differences.

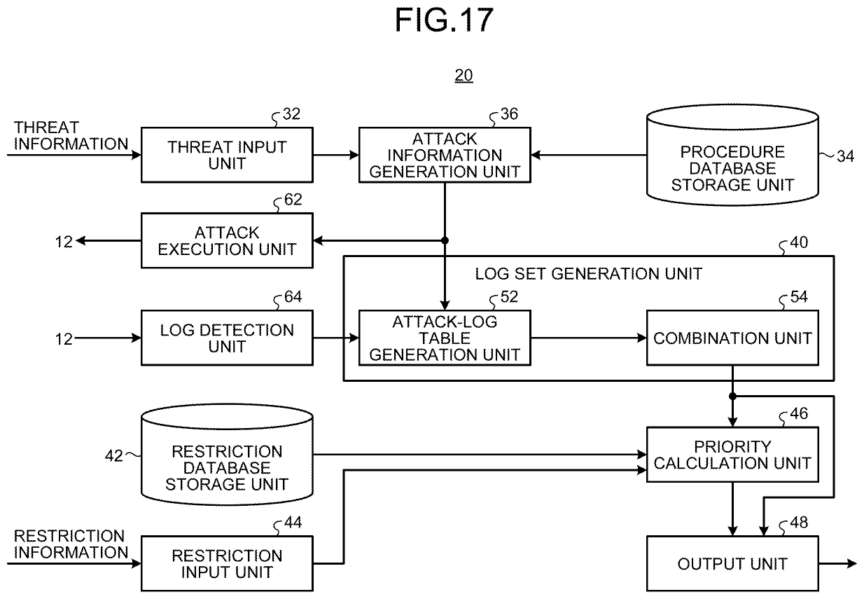

FIG. 17 is a diagram illustrating a configuration of the log recommendation device 20 according to the second embodiment.

The log recommendation device 20 according to the second embodiment includes an attack execution unit 62 and a log detection unit 64 instead of the attack-log database storage unit 38.

The attack execution unit 62 executes a plurality of attacks on the monitoring target system 12 in operation. For example, the attack execution unit 62 acquires an attack program and the like registered in advance in the database, and executes the acquired attack program to execute an attack on the monitoring target system 12. Also, in a case where there are a plurality of attack methods for a first attack among the plurality of attacks, the attack execution unit 62 may simultaneously execute the plurality of attack methods when executing the first attack.

The log detection unit 64 detects a detectable log among a plurality of logs recorded during the operation of the monitoring target system 12 for each of the plurality of executed attacks and generates an attack-log table. The log detection unit 64 analyzes each of the plurality of logs acquired from the monitoring target system 12 during the attack by the attack execution unit 62, and determines whether or not the attack has been detected. For example, the log detection unit 64 may detect a log in which a specific character string is detected during the attack by the attack execution unit 62 as a detectable log. Also, the log detection unit 64 may learn data output at the time of the normal operation by each of the plurality of logs and detect, as a detectable log, a log that outputs data that has not been learned during the attack by the attack execution unit 62. Further, in a case where the attack execution unit 62 simultaneously executes a plurality of attack methods in the first attack, the log detection unit 64 may detect a log in which all of the plurality of attack methods can be detected as a detectable log.

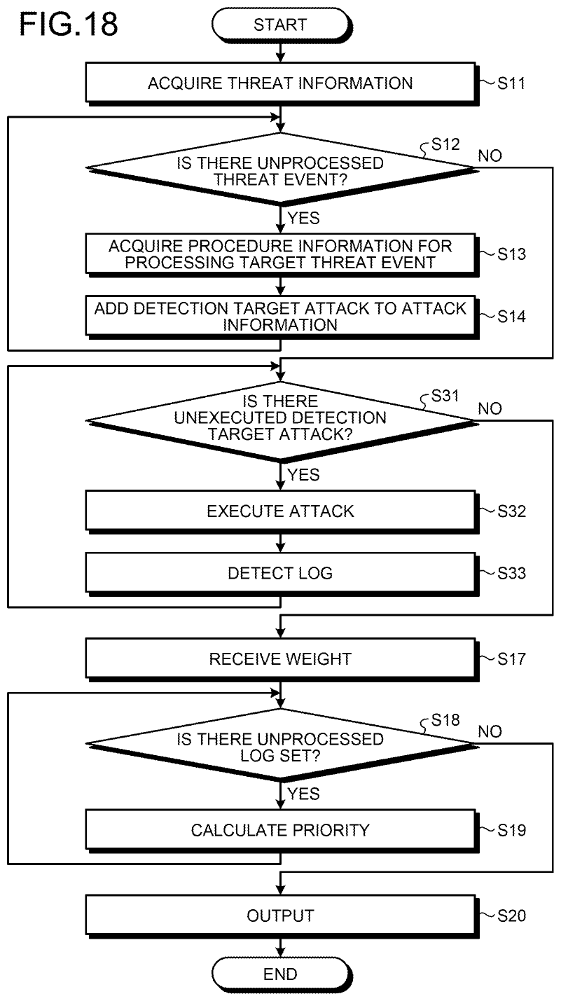

FIG. 18 is a flowchart illustrating a flow of processing of the log recommendation device 20 according to the second embodiment. The log recommendation device 20 according to the second embodiment executes processing according to the flow illustrated in FIG. 18.

First, from S11 to S14, the log recommendation device 20 executes the same processing as the processing in the first embodiment illustrated in FIG. 16. In a case where there is no unprocessed threat event (No in S12), the log recommendation device 20 advances the processing to S31.

In S31, the log recommendation device 20 determines whether or not there is an unexecuted detection target attack among a plurality of detection target attacks indicated in the attack information. In a case where there is an unexecuted detection target attack (Yes in S31), the log recommendation device 20 advances the processing to S32.

In S32, the log recommendation device 20 sets one of the unexecuted detection target attacks as a target attack, and executes the target attack on the monitoring target system 12 in operation. Subsequently, in S33, the log recommendation device 20 detects a detectable log among a plurality of logs recorded during the operation of the monitoring target system 12 during execution of the target attack. In a case where the detectable log can be detected, the log recommendation device 20 registers the detectable log in the attack-log table. Upon completion of the processing of S33, the log recommendation device 20 returns the processing to S31, and repeats the processing of S32 and S33 until there is no unexecuted detection target attack. In a case where there is no unexecuted detection target attack (No in S31), the log recommendation device 20 advances the processing to S17.

Then, from S17 to S20, the log recommendation device 20 executes the same processing as the processing in the first embodiment illustrated in FIG. 16. When the processing of S20 ends, the log recommendation device 20 ends this flow.

In the first embodiment, the attack-log table is generated with reference to the attack-log database. However, it may be difficult to identify a detectable log in advance depending on the attack. The log recommendation device 20 according to the second embodiment can reliably mechanically output a log set indicating one or more logs for detecting a threat event even in a case where there is an attack for which it is difficult to determine a detectable log in advance.

Hardware Configuration

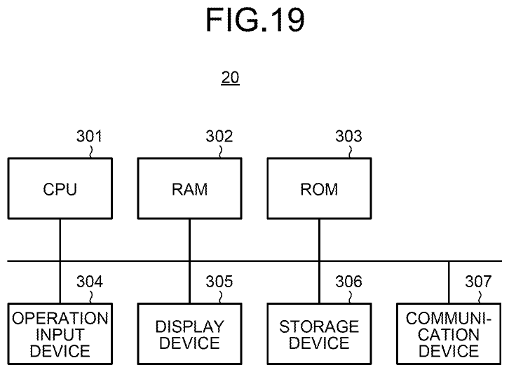

FIG. 19 is a diagram illustrating an example of a hardware configuration of the log recommendation device 20 according to each of the embodiments. The log recommendation device 20 is achieved by a computer having a hardware configuration as illustrated in FIG. 19, for example. The log recommendation device 20 includes a central processing unit (CPU) 301, a random access memory (RAN) 302, a read only memory (ROM) 303, an operation input device 304, a display device 305, a storage device 306, and a communication device 307. These units are connected by a bus.

The CPU 301 is a processor that executes arithmetic processing, control processing, and the like according to a program. The CPU 301 uses a predetermined area of the RAM 302 as a work area, and executes various kinds of processing in cooperation with programs stored in the ROM 303, the storage device 306, and the like.

The RAM 302 is a memory such as a synchronous dynamic random access memory (SDRAM). The RAM 302 functions as a work area for the CPU 301. The ROM 303 is a memory that stores programs and various types of information in a non-rewritable manner.

The operation input device 304 is an input device such as a mouse and a keyboard. The operation input device 304 receives information input from the user as an instruction signal, and outputs the instruction signal to the CPU 301.

The display device 305 is a display device such as a liquid crystal display (LCD). The display device 305 displays various types of information on the basis of a display signal from the CPU 301.

The storage device 306 is a device that writes and reads data in and from a semiconductor storage medium such as a flash memory, a magnetically or optically recordable storage medium, or the like. The storage device 306 writes and reads data in and from the storage medium under the control of the CPU 301. The communication device 307 communicates with an external device via a network under the control of the CPU 301.

The program executed by the computer has a module configuration including a threat input module, an attack information generation module, a log set generation module, a restriction input module, a priority calculation module, and an output module. The program may also include an attack execution module and a log detection module.

This program is loaded onto the RAM 302 and executed by the CPU 301 (processor), to cause the computer to function as the threat input unit 32, the attack information generation unit 36, the log set generation unit 40, the restriction input unit 44, the priority calculation unit 46, and the output unit 48. Further, this program may further cause the computer to function as the attack execution unit 62 and the log detection unit 64. Note that some or all of the threat input unit 32, the attack information generation unit 36, the log set generation unit 40, the restriction input unit 44, the priority calculation unit 46, the output unit 48, the attack execution unit 62, and the log detection unit 64 may be achieved by a hardware circuit. Also, the RAM 302 and the storage device 306 function as the procedure database storage unit 34, the attack-log database storage unit 38, and the restriction database storage unit 42.

Also, the program executed by the computer is provided by being recorded in a computer-readable recording medium such as a CD-ROM, a flexible disk, a CD-R, and a digital versatile disk (DVD) as a file in a format that can be installed or executed in the computer.

Also, the program may be stored on a computer connected to a network such as the Internet and provided by being downloaded via the network. Also, the program may be provided or distributed via a network such as the Internet. Also, the program executed by the log recommendation device 20 may be provided by being incorporated in the ROM 303 or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device comprising:
a hardware processor configured to:
acquire threat information indicating one or more threat events occurring in a monitoring target system;
generate, for each of the one or more threat events, attack information indicating a plurality of detection target attacks to be detected in order to detect the one or more threat events among a plurality of attacks launched on the monitoring target system;
generate, for each of the plurality of detection target attacks indicated in the attack information, a plurality of log sets each indicating a combination of one or more detectable logs enabling to detect all of the plurality of detection target attacks, based on an attack-log table that indicates a detectable log enabling to detect an attack among a plurality of logs acquired from the monitoring target system;
acquire, for each of the plurality of log sets, easinesses representing littleness of restrictions for monitoring the one or more detectable logs, and calculate, for each of the plurality of log sets, priorities indicating degrees of priority of monitoring, based on the easinesses of the one or more detectable logs; and
output the plurality of log sets and the priorities of the plurality of log sets.

2. The device according to claim 1, wherein the hardware processor is configured to select and output one or more log sets having higher priorities from among the plurality of log sets.

3. The device according to claim 1, wherein the hardware processor is configured to:
acquire the easinesses from a restriction database in which the easinesses are set in advance for each of the plurality of logs and each of a plurality of restriction factors that impose restrictions on execution of monitoring processing,
acquires weights of the plurality of restriction factors, and
for each of the plurality of log sets, calculate the priorities, based on total values obtained by multiplying addition values by the corresponding weights and summing them, the addition values being obtained by adding easinesses of the one or more detectable logs for each of the plurality of restriction factors.

4. The device according to claim 3, wherein the hardware processor is configured to, for each of the plurality of log sets, derive, as the priorities, values obtained by dividing the total values by numbers of the one or more detectable logs.

5. The device according to claim 3, wherein the hardware processor is configured to receive the weights of the plurality of restriction factors from a user.

6. The device according to claim 3, wherein
the plurality of restriction factors include at least one of analysis difficulty, a data generation amount, and an analysis cost,
an easiness for the analysis difficulty is lower as analysis is more difficult,
an easiness for the data generation amount is lower as an amount of data generated per unit time is larger, and
an easiness for the analysis cost is lower as analysis cost is higher.

7. The device according to claim 1, wherein the hardware processor is configured to generate the attack information, based on procedure information indicating an attack procedure of one or more attacks launched on the monitoring target system before occurrence.

8. The device according to claim 7, wherein the hardware processor is configured to, for each of the one or more threat events, cause the plurality of detection target attacks indicated in the attack information to include all of the one or more attacks indicated in the procedure information.

9. The device according to claim 7, wherein the hardware processor is configured to, for each of the one or more threat events, cause the plurality of detection target attacks indicated in the attack information to include one or more attacks with which at least a target threat event is capable of being detected among the one or more attacks indicated in the procedure information.

10. The device according to claim 1, wherein the hardware processor is configured to:
generate the attack-log table by referring to an attack-log database in which, for each of a plurality of attacks launched on the monitoring target system, a detectable log is registered in advance; and
detect combinations each including the one or more detectable logs enabling to detect all of the plurality of detection target attacks by referring to the attack-log table, to generate the plurality of log sets.

11. The device according to claim 1, wherein the hardware processor is further configured to execute the plurality of attacks on the monitoring target system in operation; and
the hardware processor is configured to detect the detectable log among the plurality of logs recorded during operation of the monitoring target system for each of the plurality of executed attacks and generate the attack-log table.

12. The device according to claim 11, wherein the hardware processor is configured to:
in a case where there are a plurality of attack methods for a first attack of the plurality of attacks, simultaneously execute the plurality of attack methods when executing the first attack, and
in a case where the first attack has been executed, detect, as the detectable log, a log enabling to detect an attack by the plurality of attack methods among the plurality of logs.

13. A computer program product comprising a computer-readable medium including programmed instructions, the instructions causing an information processing device to function as a control device, the program causing the information processing device to function as:
a threat input unit configured to acquire threat information indicating one or more threat events occurring in a monitoring target system;
an attack information generation unit configured to generate, for each of the one or more threat events, attack information indicating a plurality of detection target attacks to be detected in order to detect the one or more threat events among a plurality of attacks launched on the monitoring target system;
a log set generation unit configured to generate, for each of the plurality of detection target attacks indicated in the attack information, a plurality of log sets each indicating a combination of one or more detectable logs enabling to detect all of the plurality of detection target attacks, based on an attack-log table that indicates a detectable log enabling to detect an attack among a plurality of logs acquired from the monitoring target system;
a priority calculation unit configured to acquire, for each of the plurality of log sets, easinesses representing littleness of restrictions for monitoring the one or more detectable logs, and calculate, for each of the plurality of log sets, priorities indicating degrees of priority of monitoring, based on the easinesses of the one or more detectable logs; and
an output unit configured to output the plurality of log sets and the priorities of the plurality of log sets.

14. A control system comprising:
a monitoring target system;
a recording device configured to record a log in the monitoring target system;
a monitoring device configured to monitor a log recorded in the recording device and detect a threat event occurring in the monitoring target system; and
a control device configured to recommend a log to be monitored by the monitoring device,
wherein the control device includes:
a the hardware processor configured to:
acquire threat information indicating one or more threat events occurring in the monitoring target system;
generate, for each of the one or more threat events, attack information indicating a plurality of detection target attacks to be detected in order to detect the one or more threat events among a plurality of attacks launched on the monitoring target system;
generate, for each of the plurality of detection target attacks indicated in the attack information, a plurality of log sets each indicating a combination of one or more detectable logs enabling to detect all of the plurality of detection target attacks, based on an attack-log table that indicates a detectable log enabling to detect an attack among a plurality of logs acquired from the monitoring target system;
acquire, for each of the plurality of log sets, easinesses representing littleness of restrictions for monitoring the one or more detectable logs, and calculate, for each of the plurality of log sets, priorities indicating degrees of priority of monitoring, based on the easinesses of the one or more detectable logs; and
output the plurality of log sets and the priorities of the plurality of log sets.
